(19) United States
(12) Patent Application Publication
(10) Pub. No.: US 2004/0133725 A1
(43) Pub. Date: Jul. 8, 2004

(54) Intelligent IDE master-slave selector

(76) Inventors: Kuang-Shyr Wu, Taipei (TW); Tsung-Ming Lo, Taipei (TW); Yeun-Renn Ting, Taipei (TW)

Correspondence Address: JOHNSON & ASSOCIATES PC, 14625 BALTIMORE AVENUE #282, LAUREL, MD, 20707, US

(21) Appl. No.: 10/335,151

(22) Filed: Jan. 2, 2003

(51) Int. Cl. G06F 13/00

(52) U.S. Cl. 710/110

(57) ABSTRACT

An integrated drive electronics (IDE) master-slave selector used in a computer system with at least one hard disk drive, for users to conveniently select one hard disk drive as a master hard disk drive. The IDE master-slave selector of this present invention is characterized as an intelligent IDE master-slave selector comprising a master slave selector consisting of a first mode, a second mode, a third mode and a fourth mode. The master slave selector is mounted at the rear vacant board of a PCI/ISA slot of a computer system, and the wirings of the master-slave selection of the hard disk drive are connected beforehand, thus enabling users to switch the selector and choose one of the master-slave operation modes of the hard disk drive.

### BACKGROUND OF 1THE INVENTION

1. Field of the Invention

The present invention relates to an intelligent IDE master slave selector. More specifically, the present invention relates to a handy adjustable IDE with master-slave option technics, said master slave selector is mounted at the rear vacant board of a PCI/ISA slot of the computer system, wherein the wirings of master-slave selection of hard disk drive are connected beforehand, and thus the user may switch the selector to choose one of the master-slave operation modes of the hard disk drive.

2. Related Prior Art

Today, most personal computers are equipped with more than one hard disk drive, but the settings of these hard disk drives are not convenient for the users. Example of inconveniences and difficulties that are often experienced by potential users include, but are not limited to the following: (1) specification of the master-slave settings is not unified; (2) dismantling difficulties; (3) difficult complex settings requiring service help; (4) frequent hard disk drive breakdown often requiring maintenance; and (5) frequent use of different operation system in different hard disk.

Most prior art use withdrawable hard disk drive to install new hard disk drive or to replace old ones. Some prior art use a plurality of withdrawable hard disk to put different master slave hard disk drive into different withdrawable drawer. Thus when there is a need to replace a master-slave hard disk drive, it is much easier to draw out the hard disk drive, remove flexible wirings and exchange or adjust the master and slave. Such an approach is more convenient than fixed hard disk drive used in conventional computer. However, significant flaws still exist using this approach. First the hardware space in personal computer is insufficient. The hard disk drive can not be installed on the front panel of personal computers, and the withdrawable type hard disk drive is not applicable in this case. Although there are large spaces on the front panel, CD-ROM/DVD and CD-R/CD-RW may occupy the space at the same time.

Adjusting master-slave settings is not an easy task for skilled individuals, let alone beginners. Adjusting master-slave settings is also labor intensity.

Although the prior art withdraw hard disk drive system discussed above solves some of the systematic problems associated with the withdraw hard disk drive many difficulties remain such as lack of flexible wiring installation, problem associated with exchanging the operation system and high overall maintenance costs.

### SUMMARY OF THE INVENTION

An object of the present invention is to have an intelligent IDE master-slave selector to ease the adjustment of the IDE master-slave options through said master-slave selector, which is mounted at the rear vacant board of the PCI/ISA slot of a computer system.

Another object of this invention is to have the wirings of the master-slave selection of the hard disk drive connected beforehand, thus enabling users to switch the selector to choose one of the master-slave operation modes of the hard disk drive.

Another object of the intelligent IDE master slave selector of the present invention is to have an intelligent IDE master slave selector, including a master slave selector consisting of a first mode, a second mode, a third mode and a fourth mode.

The present invention will be readily apparent upon reading the following description of a preferred exemplified embodiment of the invention and upon reference to the accompanying drawings.

### BRIEF DESCRIPTION OF THE DRAWINGS

FIG. 1 illustrates the structure of the intelligent IDE master-slave selector of the present invention.

FIG. 2a is a front view of a preferred embodiment of the intelligent IDE master-slave selector of the present invention.

FIG. 2b is a rear view of a preferred embodiment of the intelligent IDE master-slave selector of the present invention.

### DETAILED DESCRIPTION OF THE PREFERRED EMBODIMENTS

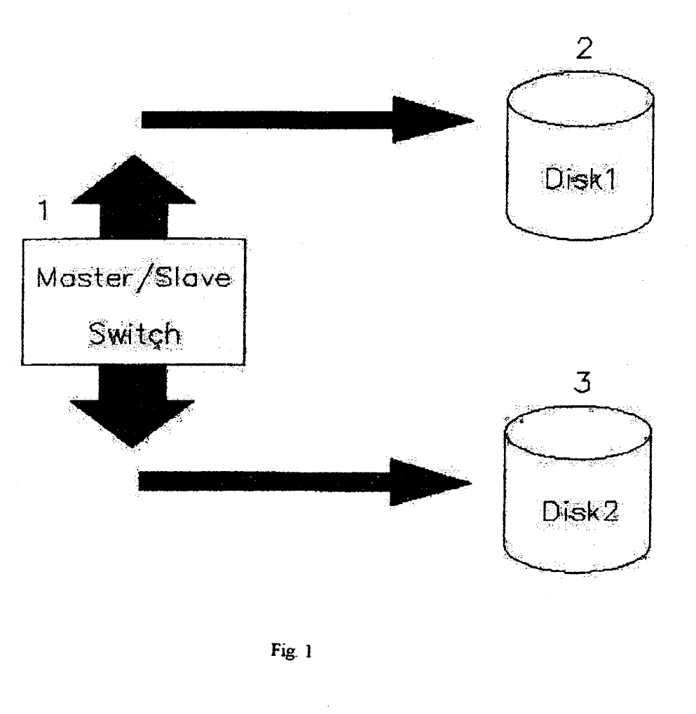

FIG. 1, shows the structure of the intelligent IDE master-slave selector of the present invention including a master-slave selector 1 mounted in a personal computer (not shown), and the personal computer having at least a hard disk drive 2 or 3. The master-slave selector 1 is mounted at the rear vacant board of the PCI/ISA slot (not shown) of the computer system, and the wirings of the master-slave selection of hard disk drive are connected beforehand, thus enabling users to switch the selector 1 to choose one of the master slave operation modes of the hard disk drive.

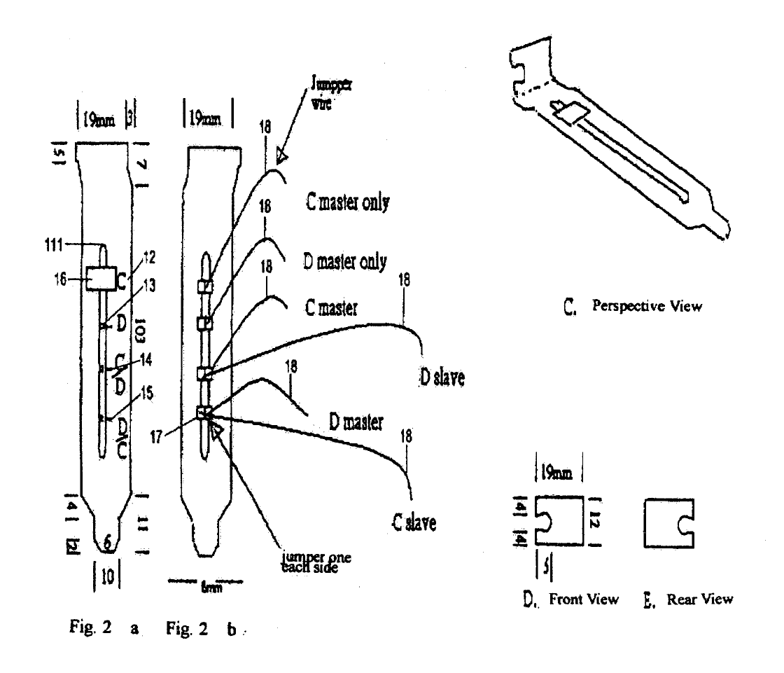

FIG. 2a, shows a front view of a preferred embodiment of the intelligent IDE master-slave selector of the present invention. Referring to FIG. 2a, the selector 1 is mounted in hole 111 of iron plate 11, consisting of a first mode 12 (C mode), a second mode 13 (D mode), a third mode 14 (C/D mode) and a fourth mode 15 (D/C mode). The first mode 12 configures one of the computer systems to use the C hard disk drive as the master hard disk drive, while the other modes are inapplicable.

The second mode 13 configures one of the computer systems to use the D hard disk drive as the master hard disk drive, while the other modes are inapplicable. Similar to the first two modes, the third mode 14 configures one of the computer systems to use the C hard disk drive as the master hard disk drive and the D hard disk drive as the slave hard disk drive. Again, similar to the first three modes, the fourth mode 15 configures one of the computer systems to use D hard disk drive as the master hard disk drive and the C hard disk drive as the slave hard disk drive.

Between the first mode 12 (C mode), the second mode 13 (D mode), the third mode 14 (C/D mode) and the fourth mode 15 (D/C mode), one mode can be selected from the four modes through a switch function of the push button 16, and by using beforehand connected master-slave selection wirings, one can complete the setting of the master-slave operation mode of the hard disk drive.

FIG. 2b shows a rear view of a preferred embodiment of the intelligent IDE master-slave selector of the present invention. Referring to FIG. 2b, the selector 1 consists of a first mode 12 (C mode), a second mode 13 (D mode), a third mode 14 (C/D mode) and a fourth mode 15 (D/C mode). The selector 1 further includes at least one short circuit metal plate 17, which is placed one each on the left and right side of hole 111 of said iron plate 11 and connected to a master slave option circuit (not shown) of the hard disk drive through cable 18 to complete the beforehand wirings of the master-slave operation mode of the hard disk drive of the personal computer.

Therefore, the present invention is capable easing the adjustment of the IDE master-slave options through the master slave selector, which is mounted at the rear vacant board of the PCI/ISA slot of a computer system, and the wirings of the master slave selection of the hard disk drive were connected beforehand, thus enabling users to switch the selector and choose one of the master-slave's operational modes of the hard disk drive.

Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. An integrated drive electronics (IDE) master-slave selector use in a computer with at least one hard disk drive for users to conveniently select one hard disk drive as a master hard disk drive; said intelligent IDE master-slave selector comprising a master-slave selector consisting of a first mode, a second mode, a third mode and a fourth mode; said master-slave selector is mounted at a rear vacant board of a PCI/ISA slot of the computer system, and wirings of said master-slave selection of the hard disk drive are connected beforehand, thus enabling users to switch said selector to choose a master-slave operation mode of the hard disk drive.

2. The integrated drive electronics (IDE) master slave selector as in claim 1, wherein said master-slave selector further comprises a push button and at least a short circuit metal plate, and one of said short circuit metal plate is on the left and the right side.

3. The integrated drive electronics (IDE) master-&lave selector as in claim 1, wherein said first mode configures said computer to use C hard disk drive as the master hard disk drive.

4. The integrated drive electronics (IDE) master-slave selector as in claim 1, wherein said second mode configures said computer to use D hard disk drive as the master hard disk drive.

5. The integrated drive electronics (IDE) master-slave selector as in claim 1, wherein said third mode configures said computer system to use the C hard disk drive as the master hard disk drive and the D hard disk drive as a slave hard disk drive.

6. The integrated drive electronics (IDE) master slave selector as in claim 1, wherein said fourth mode configures said computer to use the D hard disk drive as the master hard disk drive and the C hard disk drive as a slave hard disk drive.
